(19) United States
(12) Patent Application Publication
(10) Pub. No.: US 2025/0269317 A1
(43) Pub. Date: Aug. 28, 2025

(54) TWO-STAGE CARBON DIOXIDE ADSORPTION USING COLLAPSED ZEOLITE WITH ULTRA-SMALL PORES

(71) Applicant: Saudi Arabian Oil Company, Dhahran (SA)

(72) Inventors: Ali A. Almofleh, Dhahran (SA); Georgios Lithoxoos, Dhahran (SA); Rashid M. Othman, Khobar (SA)

(21) Appl. No.: 18/587,656

(22) Filed: Feb. 26, 2024

(30) Foreign Application Priority Data
Feb. 22, 2024 (GR) 20240100130

(51) Int. Cl. B01D 53/04; B01D 53/26; B01D 53/28

(52) U.S. Cl. CPC B01D 53/0423; B01D 53/261; B01D 53/28; B01D 2253/1085; B01D 2253/308; B01D 2257/504; B01D 2257/80; B01D 2258/06; B01D 2259/40083

(57) ABSTRACT

A method of separating carbon dioxide (CO₂) from air, where the method includes: feeding air into a cooler to generate cooled air, the cooled air including nitrogen (N₂), oxygen (O₂), water (H₂O), and CO₂; feeding the cooled air to a first adsorption column including a first zeolite adsorbent to selectively capture the H₂O from the cooled air, generating dried cooled air; and feeding the dried cooled air to a second adsorption column including a second zeolite adsorbent to selectively capture the CO₂ from the dried cooled air, generating a tail gas, wherein the second zeolite adsorbent includes a Linde Type A (LTA) aluminosilicate zeolite that is hydrolyzed and at least partially collapsed.

### TECHNICAL FIELD

This disclosure relates to methods and systems of two-stage carbon dioxide (CO₂) adsorption using collapsed zeolite with ultra-small pores.

### BACKGROUND

With the rising concerns of climate change and greenhouse gas emissions, governments and companies are looking for ways to reduce their energy intensity and carbon footprint. Because the rising atmospheric carbon dioxide (CO₂) concentration has been reported as the major factor of the climate change, various technologies are needed to reduce the CO₂ emissions form industry. Such technologies include CO₂ separation, transportation, and sequestration.

### SUMMARY

This disclosure describes technologies relating to methods and systems of two-stage carbon dioxide (CO₂) adsorption from air using collapsed zeolite.

### BRIEF DESCRIPTION OF DRAWINGS

FIG. 1 is a block diagram of two-stage carbon dioxide (CO₂) adsorption using a partially collapsed zeolite.

FIGS. 2A-2B are process flow diagrams of the method of CO₂ adsorption.

FIG. 3 is a graph of the gas adsorption capacity of collapsed zeolite adsorbents.

FIG. 4 is a graph of the gas selectivity of collapsed zeolite adsorbents.

### DETAILED DESCRIPTION

Implementations described herein provide methods and systems of two-stage CO₂ adsorption from a gas stream, e.g., atmospheric air or process tail gas from oil and gas production, using a collapsed zeolite adsorbent. The first stage of the process selectively adsorbs water (H₂O) in the gas stream and the second stage subsequently uses the collapsed zeolite to selectively capture CO₂ from the dried gas stream. Accordingly, in various implementations, the system of two-stage CO₂ adsorption can include: a) a fan or compressor for directing the gas stream to a cooler; b) a cooler for lowering the temperature of the gas stream; c) a first stage adsorption unit for H₂O separation; and d) a second stage adsorption unit for CO₂ separation.

The two-stage CO₂ adsorption described in this disclosure can be applied to direct air capture (DAC), a physical or chemical process to separate CO₂ from the atmospheric air. Using the partially collapsed zeolite adsorbents, the two-stage CO₂ adsorption can improve the DAC process efficiency and thereby reduce the separation cost compared with other technologies such as liquid adsorption (e.g., amine or alkali and alkali earth hydroxide). The two-stage CO₂ adsorption can also advantageously be performed as a continuous process using multiple adsorption columns, where one column can be regenerated while another column is used for adsorption.

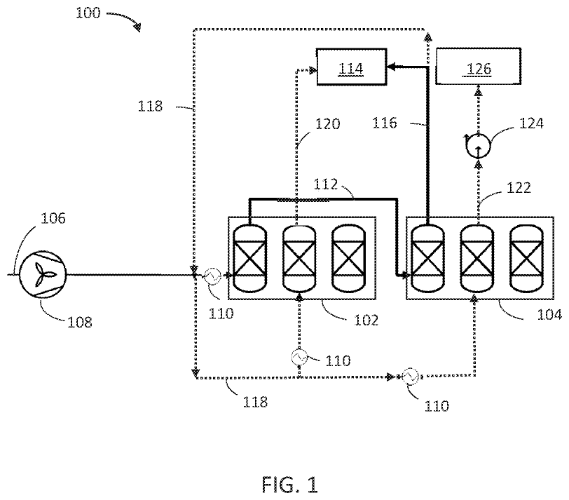

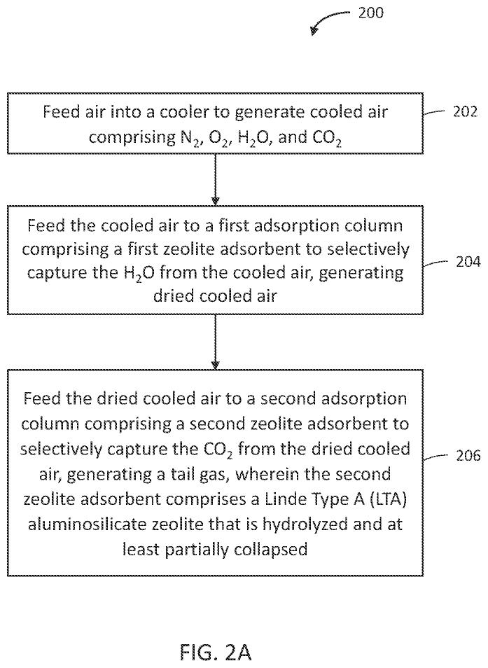

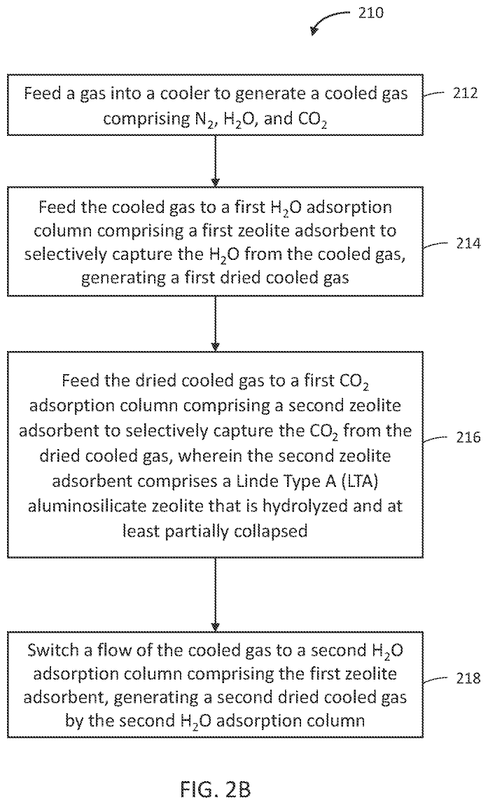

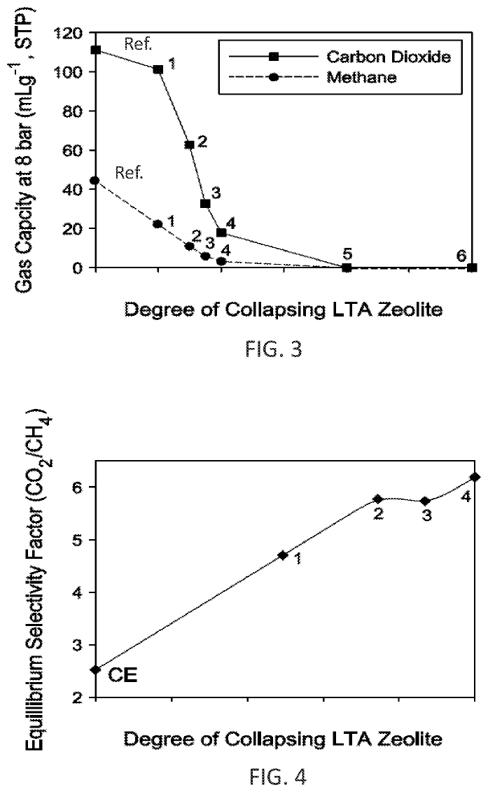

In the following, the method and system of two-stage CO₂ adsorption is described referring to FIG. 1. FIGS. 2A-2B are example process flow diagrams for the method of CO₂ adsorption. Examples experimental results are then described referring to FIGS. 3-4.

### Two-Stage CO₂ Separation Using Collapsed Zeolite

FIG. 1 is a block diagram of two-stage CO₂ adsorption 100. Solid and dotted arrows indicate gas flows such as inflow and outflow, where the two types of arrows are used to suggest the temporal separation or alternate operations. In various implementations, the two-stage CO₂ adsorption 100 is used to capture CO₂ directly from the atmospheric air. In some implementations, the two-stage CO₂ adsorption 100 is a part of the oil and gas production/refinery facility and captures CO₂ from the tail gas.

In FIG. 1, the system of the two-stage CO₂ adsorption 100 can include a H₂O adsorption unit 102 followed by a CO₂ adsorption unit 104. In FIG. 1, each unit has, for example, three adsorption columns that can be configured to operate alternatively. For illustration purpose, some gas flows, e.g., gas flows from and to a third column, are omitted in FIG. 1.

In various implementations, each unit has one or more columns, and the number of columns can be selected based on the volume of each column and required process capacity, e.g., target air flow rate, for the two-stage CO₂ adsorption 100.

In operation, a feed gas 106 is sent to a fan 108 configured to deliver the feed gas to the H₂O adsorption unit 102. In various implementations, the feed gas 106 is atmospheric air. The feed gas 106 can therefore contain nitrogen (N₂), oxygen (O₂), H₂O, and CO₂. For example, the feed gas 106 can contain about 78.1 mol % N₂, about 20.9 mol % O₂, 0.9 mol % argon (Ar), about 400 parts per million (ppm) CO₂. In some implementations, the feed gas 106 is air containing between about 380 ppm and about 420 ppm. In one embodiment, the feed gas 106 contains 380 ppm CO₂ or greater. In one or more implementations, the H₂O content in the feed gas 106 can be between 0 mol % and about 3 mol %. Further, the feed gas 106 can also contain helium (He), methane (CH₄), argon (Ar), or hydrogen (H₂), depending on the source of the feed gas 106.

The fan 108 can include or be a part of a compressor to compress the feed gas 106. In some implementations, the feed gas 106 can be compressed to a pressure of 10 bar (1 MPa) or less, for example, about 8 bar (0.8 MPa).

The feed gas 106 can be cooled using a heat exchanger 110 before being sent to the first stage of adsorption. In some implementations, the feed gas 106 is cooled to a temperature between −50° C. and 50° C., for example about 25° C. The temperature of the feed gas 106 can be adjusted to the target adsorption temperature of the first stage. In FIG. 1, each column can be equipped with designated one of the heat exchangers 110. In some implementations, one heat exchanger can be used for more than one adsorption column. Further, depending on the initial H₂O content in the feed gas 106, the two-stage CO₂ adsorption 100 can include a condenser to condense H₂O by cooling the feed gas 106, where the H₂O adsorption unit 102 is configured to capture the residual H₂O in the feed gas 106.

In various implementations, the adsorption columns of the H₂O adsorption unit 102 are charged with a first zeolite adsorbent that can selectively adsorb H₂O from the feed gas 106. The first zeolite adsorbent can be, for example, molecular sieve 3A. Molecular sieve 3A is a synthetic crystalline aluminosilicate with a regular micropores structure characterized with a pore diameter about 3 angstrom (A). It is commonly used for drying of various gases and polar liquids. The H₂O adsorption can be performed at between −50° C. and 50° C., for example about 25° C. and at 10 bar (1 MPa) or less, for example, about 8 bar (0.8 MPa). The H₂O molecules can be selectively adsorbed while the rest of the gases pass through the column bed towards the CO₂ adsorption as a dried gas 112 in FIG. 1. The adsorbed H₂O can be recovered separately during the regeneration process of the column. In some implementations, the H₂O content in the dried gas 112 is about 4 ppm or less, for example, less than 2 ppm. The dried gas 112 can then be sent to the CO₂ adsorption unit 104.

After the H₂O adsorption, the CO₂ adsorption from the dried gas 112 can be performed in the CO₂ adsorption unit 104. In various implementations, the adsorption columns of the CO₂ adsorption unit 104 are charged with a second zeolite adsorbent. The second zeolite adsorbent can be a zeolite-based adsorbent that is processed to lose the crystallinity partially or entirely by structural collapse of a precursor zeolite material. In some implementations, the second zeolite adsorbent includes a Linde Type A (LTA) aluminosilicate zeolite that is hydrolyzed and at least partially collapsed. The structural collapse can decrease the average pore size of the precursor zeolite material, improving the CO₂ adsorption performance such as CO₂ selectivity. This class of partially collapsed aluminosilicate adsorbents is referred to as “ultra-small pore aluminosilicates” in this disclosure. The ultra-small pore aluminosilicates can be an amorphous material showing no substantial peak in X-ray diffraction (XRD) measurements.

In some implementations, the ultra-small pore aluminosilicates as the adsorbent for the two-stage CO₂ adsorption in this disclosure can be synthesized according to the procedure described in U.S. Pat. No. 9,333,482B2, the disclosure of which is incorporated herein by reference. For example, a commercially available sodium LTA zeolite with small-pore size (pore diameter ˜4 angstrom (Å)) (also referred to as “NaA”) can be used as the precursor for forming the amorphous adsorbent. Briefly, the method for forming the ultra-small pore aluminosilicates includes ion-exchange, calcination and liquid H₂O treatment, e.g., at a temperature around 25° C. or higher, of the precursor to irreversibly transform the crystalline aluminosilicate zeolite with a small pore size into the highly selective, ultra-small pore size amorphous adsorbent. Therefore, ultra-small pore aluminosilicates generally have an average pore size smaller than the precursor zeolite such as NaA. In other implementations, the liquid H₂O treatment of the precursor may be replaced with steam treatment, including superheated steam. These treatments with H₂O can induce hydrolysis of the material and result in a hydrolyzed aluminosilicate. The introduction of water following calcination results in the hydrolysis of destabilized Si—O—Al bonds. The hydrolysis of susceptible Si—O—Al bonds may lead to additional pore size narrowing for enhancing the selectivity properties of the adsorbent composition without adversely impacting the adsorption capacity of the material.

In some implementations, the ion-exchange can be performed using an ammonium (NH₄⁺) ion. Accordingly, the second zeolite adsorbent (the ultra-small pore aluminosilicates) includes Na and NH₄⁺ ions. In reacting an NH₄⁺ containing ion-exchange material with a sodium aluminosilicate zeolite such as NaA, the Na/Al ratio will decrease with an increased degree of NH₄⁺ substitution for the Na⁺ cation of the crystalline zeolite. In one implementation, the ultra-small pore aluminosilicates have a Na/Al ratio in a range of from about 0.60 to about 1.00. In other implementations, the ultra-small pore aluminosilicates have a Na/Al ratio in a range of from about 0.60 to about 0.77. Here, the “cation/Al ratio” is the stoichiometric ratio of the exchangeable zeolite cation to aluminum in the zeolite, for instance, a sodium aluminosilicate zeolite such as NaA is expressed as a “Na/Al ratio”. The degree of cation exchange is dependent on both the temperature and the cation concentration in the ion-exchange material.

The cation-exchanged zeolite may begin collapsing at temperatures greater than about 100° C. In some implementations, the calcination temperature is in a range of from about 200° C. to about 500° C., for instance about 400° C. Alternatively, thermally collapsing a sodium aluminosilicate zeolite such as NaA in the absence of cation exchange requires high calcination temperatures, for example temperatures greater than about 700° C. However, the resulting collapsed zeolite structure is non-porous and therefore unsuitable for performing molecular separations.

In some implementations, the ultra-small pore aluminosilicates for the second zeolite adsorbent can have pores characterized by a pore aperture size of from 0.33 nanometer (nm) to 0.38 nm, smaller than the pore size of the original NaA (0.4 nm). Further, the second zeolite adsorbent can also be characterized by a CO₂/CH₄ equilibrium selectivity factor in a range of 3.8 to 40. Although not wishing to be limited by any theory, the second zeolite adsorbent can exhibit CO₂ selectivity based on the difference in polarizabilities of the gases (CO₂=2.507 cubic angstrom (Å³), O₂=1.562 Å³, N₂=1.710 Å³) and the difference in their kinetic diameters (CO₂=330 picometer (pm), O₂=346 in pm, N₂=364 pm). The ultra-small pore aluminosilicates can, with its polarity, attract CO₂ molecules more than O₂ molecules and has a pore size which prohibits the entrance of molecules larger than CO₂.

The CO₂ adsorption can be performed at between −50° C. and 50° C., for example about 25° C. and at 10 bar (1 MPa) or less, for example, about 8 bar (0.8 MPa). In some implementations, the CO₂ adsorption temperature and pressure can be same as those for the H₂O adsorption, but they can be selected independently and set differently in other implementations. The CO₂ molecules can be selectively adsorbed while the rest of the gases pass through the column bed towards a vent 114 as a tail gas 116 in FIG. 1. The tail gas 116 obtained after the CO₂ adsorption can be a mixture of O₂, N₂, and Ar. In some implementations, the CO₂ content in the tail gas 116 is about 10 ppm or less, for example, less than 5 ppm. In one or more implementations, the CO₂ adsorption can be performed to reduce the CO₂ content in the feed gas 106 to any level, for example, about 300 ppm or less in the tail gas 116. A slip stream 118 of the tail gas 116 can be looped back and after being heated it is used for the regeneration of the H₂O adsorption unit 102, the CO₂ adsorption unit 104, or both.

### Multiple Adsorption Columns

As illustrated in FIG. 1, the system of the two-stage CO₂ adsorption 100 can include multiple adsorption columns for each of the H₂O adsorption unit 102 and the CO₂ adsorption unit 104. In various implementations, the H₂O adsorption can be performed using a first H₂O adsorption column until its adsorbent reaches its capacity and saturation. Once the first adsorbent bed is saturated, the flow of the feed gas 106 to the first H₂O adsorption column can be stopped, and the flow is switched to a second H₂O adsorption column to continue the H₂O adsorption, while the first H₂O adsorption column becomes available for regeneration.

The adsorbed H₂O can be released from the column by a regeneration process. For example, a humid gas 120 can be formed by flowing the slip stream 118 or using vacuum and sent to the vent 114 as illustrated in FIG. 1, or to a condenser to condense H₂O. The slip steam 118 can be further split into two or more streams for regeneration of multiple adsorption columns of the H₂O adsorption unit 102, the CO₂ adsorption unit 104, or both.

In some implementations, the regeneration can include guiding the slip stream 118 through a fired heat blower, to elevate the column temperature and release the adsorbed molecules. After completing the regeneration, the adsorption column becomes available for another adsorption stage. The adsorption-regeneration cycle can be based on temperature-swing mechanism, pressure-swing mechanism, or both.

Similarly, the CO₂ adsorption can be performed using a first CO₂ adsorption column until its adsorbent reaches its capacity and saturation. Once the first adsorbent bed is saturated, the flow of the dried gas 112 to the first CO₂ adsorption column can be stopped, and the flow is switched to a second CO₂ adsorption column to continue the CO₂ adsorption, while the first CO₂ adsorption column becomes available for regeneration.

The adsorbed CO₂ can be released from the column by a regeneration process. For example, a CO₂-rich gas 122 can be formed by flowing a carrier gas or using a vacuum pump 124 to apply vacuum and sent to a CO₂ sequestration unit 126, such as a CO₂ liquefaction unit, as illustrated in FIG. 1. In some implementations, CO₂ sequestration unit 12 can be connected to a facility for permanent storage, e.g., by underground sequestration. After completing the regeneration, the adsorption column becomes available for another adsorption stage. The adsorption-regeneration cycle can be based on temperature-swing mechanism, pressure-swing mechanism, or both. Accordingly, each of the H₂O adsorption unit 102 and the CO₂ adsorption unit 104 can include one or more temperature controller to maintain the process temperatures for adsorption and regeneration.

Having multiple adsorption columns can allow a continuous adsorption-regeneration process without interruption. For example, for either of H₂O or CO₂ adsorption, the method can include (1) flowing the gas, e.g., the feed gas 106 or the dried gas 112, to a first adsorption column until its saturation; (2) stopping the gas flow to the first adsorption column; (3) flowing the gas to a second adsorption column; (4) regenerating the first adsorption column while adsorbing H₂O or CO₂ using the second adsorption column; (5) after regeneration, switching the gas flow back to the first adsorption column; (6) regenerating the second adsorption column while adsorbing H₂O or CO₂ using the first adsorption column; and (7) repeating the steps (2)-(6). Accordingly, the system of two-stage CO₂ adsorption 100 can include a gas flow control system configured to switch the feed gas 106 and the dried gas 112 between different adsorption columns. As illustrated in FIG. 1, in some implementations, the system of two-stage CO₂ adsorption 100 can have three adsorption columns for each stage. In these implementations, a first column can be used for adsorption, while a second column is being regenerated and a third column is standing by.

The steps of the continuous cyclic adsorption-regeneration process can be modified and adopted in various ways depending on the number of adsorption columns and adsorption capacity of each column. In some implementations, the switching of the columns can be synchronized between the H₂O and CO₂ adsorption, where the dried gas from the first H₂O adsorption column is sent to the first CO₂ adsorption column and another dried gas from the second H₂O adsorption column is sent to the second CO₂ adsorption column. In these implementations, the regeneration of the first H₂O adsorption column and the first CO₂ adsorption column can be performed simultaneously.

In some implementations, the gas, e.g., the feed gas 106 and the dried gas 112, can be sent to more than one adsorption columns at the same time. For example, the feed gas 106 can be sent to first two H₂O adsorption columns while a third H₂O adsorption column is being regenerated. The gas delivery for adsorption and regeneration between multiple adsorption columns can be selected in consideration of various parameters such as the column volume, the adsorption capacity, and the adsorbent conditions.

FIGS. 2A-2B are example process flow diagrams of a method of the two-stage CO₂ adsorption 100 as described above. In FIG. 2A, a method 200 according to an implementation starts with feeding air 202 into a cooler to generate cooled air, where the cooled air includes nitrogen (N₂), oxygen (O₂), water (H₂O), and CO₂, followed by feeding the cooled air 204 to a first adsorption column including a first zeolite adsorbent to selectively capture the H₂O from the cooled air, generating dried cooled air. Subsequently, the dried cooled air is fed 206 to a second adsorption column including a second zeolite adsorbent to selectively capture the CO₂ from the dried cooled air, generating a tail gas, where the second zeolite adsorbent includes a Linde Type A (LTA) aluminosilicate zeolite that is hydrolyzed and at least partially collapsed.

In FIG. 2B, another method 210 according to an implementation of the system of the two-stage CO₂ adsorption 100 starts with feeding a gas 212 into a cooler to generate a cooled gas, the cooled gas including N₂, H₂O, and CO₂, followed by feeding the cooled gas 214 to a first H₂O adsorption column including a first zeolite adsorbent to selectively capture the H₂O from the cooled gas, generating first dried cooled gas. The first dried cooled gas is then fed 216 to a first CO₂ adsorption column including a second zeolite adsorbent to selectively capture the CO₂ from the first dried cooled gas, where the second zeolite adsorbent comprises a Linde Type A (LTA) aluminosilicate zeolite that is hydrolyzed and at least partially collapsed. Subsequently, a flow of the cooled gas can be switched 218 to a second H₂O adsorption column including the first zeolite adsorbent, generating a second dried cooled gas by the second H₂O adsorption column.

### EXAMPLES

To demonstrate the performance of collapsed zeolite adsorbents, adsorption experiments were carried out using LTA zeolite samples with a varying degree of structural collapse.

The collapsed zeolite adsorbents were prepared by ion-exchange and calcination of a sodium LTA zeolite (NaA). An aqueous solution of ammonium nitrate (NH₄NO₃) at various concentrations was used for the ion-exchange with varying degree of structural collapse. Each sample was synthesized by initially suspending 1 gram of the NaA zeolite in 20 mL of NH₄NO₃ solution and the solution was stirred for six hours at room temperature to form ion-exchanged zeolite precursors. The ammonium (NH₄⁺) ion substitutes for the sodium (Na⁺) ion to varying degrees based upon the ammonium nitrate concentration. The ammonium nitrate concentration was increased from about 0.14 M to about 0.42 M from sample 1 to 6, resulting in decreasing Na/Al ratio. The precursors are collected by filtration, washed with deionized water followed by acetone, and dried at 333 K for 24 hours. The dried, ion-exchanged zeolite precursors were then calcined in a plug-flow reactor under flowing dry air (25 mL/minute) at 673 K (temperature ramp: 1 K/minute) for 2 hours.

FIG. 3 shows a graph of the CO₂ and CH₄ gas adsorption capacities at 8 bar (0.8 MPa). A higher degree of cation exchange is assumed to correlate to a greater degree of structural collapse, and therefore the Na/Al ratio is determined and used as the parameter representing the degree of structural collapse.

While both CO₂ and CH₄ adsorption capacities decrease as the collapse of the zeolite structure progresses, the CH₄ adsorption capacity decreases more rapidly than the CO₂ adsorption capacity. Although not wishing to be limited by any theory, the pore size decreases with the progression of structural collapse and the kinetic diameter of CH₄ (ca. 380 pm) is larger than CO₂ (ca. 330 pm). As a result, CH₄ molecules can be excluded more upon the reduction in pore size. The same trend is expected with ambient air gases such as N₂ and O₂ with their kinetic diameters of ca. 364 μm and 346 pm, respectively. With the continued progression of structural collapse, the zeolite adsorbent eventually loses its adsorption capacity entirely in both CO₂ and CH₄. This result demonstrates the advantage of controlling the degree of structural collapse in preparation of the adsorbent to achieve “partially collapsed” zeolite adsorbent.

FIG. 4 shows a graph of the CO₂ and CH₄ gas adsorption selectivity at 298 K and 8 bar (0.8 MPa). The data were collected for the “partially collapsed” samples that exhibited some CO₂ adsorption capacity in the previous experiments described above. The CO₂ selectivity over CH₄ improves from about 2.5 to about 5.7 with the structural collapse. Accordingly, the preparation of the “partially collapsed” zeolite adsorbent can be carried out in consideration of the balance between the loss of the CO₂ adsorption capacity and the improvement in CO₂ selectivity due to the structural collapse.

### Implementations

An implementation described herein provides a method of separating carbon dioxide (CO₂) from air, where the method includes: feeding air into a cooler to generate cooled air, the cooled air including nitrogen (N₂), oxygen (O₂), water (H₂O), and CO₂; feeding the cooled air to a first adsorption column including a first zeolite adsorbent to selectively capture the H₂O from the cooled air, generating dried cooled air; and feeding the dried cooled air to a second adsorption column including a second zeolite adsorbent to selectively capture the CO₂ from the dried cooled air, generating a tail gas, wherein the second zeolite adsorbent includes a Linde Type A (LTA) aluminosilicate zeolite that is hydrolyzed and at least partially collapsed.

In an aspect, combinable with any other aspect, the air is atmospheric air.

In an aspect, combinable with any other aspect, the air has a CO₂ concentration of 380 parts per million (ppm) or greater.

In an aspect, combinable with any other aspect, the air further includes helium (He), methane (CH₄), argon (Ar), or hydrogen (H₂).

In an aspect, combinable with any other aspect, the cooled air has a temperature between −50° C. and 50° C.

In an aspect, combinable with any other aspect, the method further includes maintaining temperatures of the first adsorption column and the second adsorption column between −50° C. and 50° C.

In an aspect, combinable with any other aspect, the cooled air has a pressure of 10 bar (1 MPa) or less.

In an aspect, combinable with any other aspect, the first zeolite adsorbent includes a molecular sieve 3A.

In an aspect, combinable with any other aspect, the LTA aluminosilicate zeolite includes a plurality of pores characterized by a pore aperture size of from 0.33 nm to 0.38 nm.

In an aspect, combinable with any other aspect, the LTA aluminosilicate zeolite is characterized by a carbon dioxide/methane equilibrium selectivity factor in a range of 3.8 to 40.

In an aspect, combinable with any other aspect, the LTA aluminosilicate zeolite has a Na/Al ratio in a range of from 0.60 to 1.00.

In an aspect, combinable with any other aspect, the LTA aluminosilicate zeolite includes ammonium cations (NH₄⁺).

An implementation described herein provides a method of separating carbon dioxide (CO₂) from a gas stream, where the method includes: feeding a gas into a cooler to generate a cooled gas, the cooled gas including nitrogen (N₂), water (H₂O), and CO₂; feeding the cooled gas to a first H₂O adsorption column including a first zeolite adsorbent to selectively capture the H₂O from the cooled gas, generating first dried cooled gas; feeding the first dried cooled gas to a first CO₂ adsorption column including a second zeolite adsorbent to selectively capture the CO₂ from the first dried cooled gas, wherein the second zeolite adsorbent includes a Linde Type A (LTA) aluminosilicate zeolite that is hydrolyzed and at least partially collapsed; and switching a flow of the cooled gas to a second H₂O adsorption column including the first zeolite adsorbent, generating a second dried cooled gas by the second H₂O adsorption column.

In an aspect, combinable with any other aspect, the method further includes feeding the second dried cooled gas to a second CO₂ adsorption column including the second zeolite adsorbent.

In an aspect, combinable with any other aspect, the method further includes, after the switching, regenerating the first H₂O adsorption column by releasing the H₂O captured by the first zeolite adsorbent.

In an aspect, combinable with any other aspect, the method further includes switching a flow of the first dried cooled gas to a second CO₂ adsorption column including the second zeolite adsorbent.

In an aspect, combinable with any other aspect, the method further includes stopping to feed the first dried cooled gas to the first CO₂ adsorption column; and regenerating the first CO₂ adsorption column by releasing the CO₂ captured by the second zeolite adsorbent.

An implementation described herein provides a system of separating carbon dioxide (CO₂) from air, where the system includes: a cooler to cool a feed gas; an H₂O adsorption column to receive the feed gas from the cooler and to discharge a dried gas, the H₂O adsorption column including a first zeolite adsorbent; and a CO₂ adsorption column to receive the dried gas from the H₂O adsorption column and to discharge a tail gas, the CO₂ adsorption column including a second zeolite adsorbent, the second zeolite adsorbent including a Linde Type A (LTA) aluminosilicate zeolite that is hydrolyzed and at least partially collapsed.

In an aspect, combinable with any other aspect, the system further includes an additional H₂O adsorption column to receive the feed gas from the cooler and to discharge a second dried gas, the additional H₂O adsorption column including the first zeolite adsorbent; and an additional CO₂ adsorption column to receive the second dried gas from the additional H₂O adsorption column and to discharge a second tail gas, the additional CO₂ adsorption column including the second zeolite adsorbent.

In an aspect, the system further includes a gas flow control system configured to switch a delivery of the feed gas between to the H₂O adsorption column and to the additional H₂O adsorption column.

While this invention has been described with reference to illustrative implementations, this description is not intended to be construed in a limiting sense. Various modifications and combinations of the illustrative implementations, as well as other implementations of the invention, will be apparent to persons skilled in the art upon reference to the description. It is therefore intended that the appended claims encompass any such modifications or implementations.

What is claimed is:

1. A method of separating carbon dioxide (CO₂) from air, the method comprising:
feeding air into a cooler to generate cooled air, the cooled air comprising nitrogen (N₂), oxygen (O₂), water (H₂O), and CO₂;
feeding the cooled air to a first adsorption column comprising a first zeolite adsorbent to selectively capture the H₂O from the cooled air, generating dried cooled air; and
feeding the dried cooled air to a second adsorption column comprising a second zeolite adsorbent to selectively capture the CO₂ from the dried cooled air, generating a tail gas, wherein the second zeolite adsorbent comprises a Linde Type A (LTA) aluminosilicate zeolite that is hydrolyzed and at least partially collapsed.

2. The method of claim 1, wherein the air is atmospheric air.

3. The method of claim 1, wherein the air has a CO₂ concentration of 380 parts per million (ppm) or greater.

4. The method of claim 1, wherein the air further comprises helium (He), methane (CH₄), argon (Ar), or hydrogen (H₂).

5. The method of claim 1, wherein the cooled air has a temperature between −50° C. and 50° C.

6. The method of claim 1, further comprising maintaining temperatures of the first adsorption column and the second adsorption column between −50° C. and 50° C.

7. The method of claim 1, wherein the cooled air has a pressure of 10 bar (1 MPa) or less.

8. The method of claim 1, wherein the first zeolite adsorbent comprises a molecular sieve 3A.

9. The method of claim 1, wherein the LTA aluminosilicate zeolite comprises a plurality of pores characterized by a pore aperture size of from 0.33 nm to 0.38 nm.

10. The method of claim 1, wherein the LTA aluminosilicate zeolite is characterized by a carbon dioxide/methane equilibrium selectivity factor in a range of 3.8 to 40.

11. The method of claim 1, wherein the LTA aluminosilicate zeolite has a Na/Al ratio in a range of from 0.60 to 1.00.

12. The method of claim 1, wherein the LTA aluminosilicate zeolite comprises ammonium cations (NH₄⁺).

13. A method of separating carbon dioxide (CO₂) from a gas stream, the method comprising:
feeding a gas into a cooler to generate a cooled gas, the cooled gas comprising nitrogen (N₂), water (H₂O), and CO₂;
feeding the cooled gas to a first H₂O adsorption column comprising a first zeolite adsorbent to selectively capture the H₂O from the cooled gas, generating first dried cooled gas;
feeding the first dried cooled gas to a first CO₂ adsorption column comprising a second zeolite adsorbent to selectively capture the CO₂ from the first dried cooled gas, wherein the second zeolite adsorbent comprises a Linde Type A (LTA) aluminosilicate zeolite that is hydrolyzed and at least partially collapsed; and
switching a flow of the cooled gas to a second H₂O adsorption column comprising the first zeolite adsorbent, generating a second dried cooled gas by the second H₂O adsorption column.

14. The method of claim 13, further comprising feeding the second dried cooled gas to a second CO₂ adsorption column comprising the second zeolite adsorbent.

15. The method of claim 13, further comprising, after the switching, regenerating the first H₂O adsorption column by releasing the H₂O captured by the first zeolite adsorbent.

16. The method of claim 13, further comprising switching a flow of the first dried cooled gas to a second CO₂ adsorption column comprising the second zeolite adsorbent.

17. The method of claim 13, further comprising:
stopping to feed the first dried cooled gas to the first CO₂ adsorption column; and
regenerating the first CO₂ adsorption column by releasing the CO₂ captured by the second zeolite adsorbent.

18. A system of separating carbon dioxide (CO₂) from air, the system comprising:
a cooler to cool a feed gas;
an H₂O adsorption column to receive the feed gas from the cooler and to discharge a dried gas, the H₂O adsorption column comprising a first zeolite adsorbent; and
a CO₂ adsorption column to receive the dried gas from the H₂O adsorption column and to discharge a tail gas, the CO₂ adsorption column comprising a second zeolite adsorbent, the second zeolite adsorbent comprising a Linde Type A (LTA) aluminosilicate zeolite that is hydrolyzed and at least partially collapsed.

19. The system of claim 18, further comprising:
an additional H₂O adsorption column to receive the feed gas from the cooler and to discharge a second dried gas, the additional H₂O adsorption column comprising the first zeolite adsorbent; and
an additional CO₂ adsorption column to receive the second dried gas from the additional H₂O adsorption column and to discharge a second tail gas, the additional CO₂ adsorption column comprising the second zeolite adsorbent.

20. The system of claim 19, further comprising a gas flow control system configured to switch a delivery of the feed gas between to the H₂O adsorption column and to the additional H₂O adsorption column.
